(19) United States
(12) Patent Application Publication
(10) Pub. No.: US 2026/0302789 A1
(43) Pub. Date: Oct. 1, 2026

(54) POWER MANAGEMENT APPARATUS AND POWER MANAGEMENT METHOD

(71) Applicant: HONDA MOTOR CO., LTD., Tokyo (JP)

(72) Inventor: Takayuki Sakurai, Tokyo (JP)

(21) Appl. No.: 19/534,866

(22) Filed: Feb. 10, 2026

(30) Foreign Application Priority Data
Mar. 27, 2025 (JP) 2025-054026

(51) Int. Cl. H02J 3/32; B60L 55/00; H02J 3/17

(52) U.S. Cl. CPC H02J 3/322; B60L 55/00; H02J 3/17

(57) ABSTRACT

A power management apparatus includes: an acquisition unit that acquires an assumed capacity and an assumed output of a plurality of vehicle groups corresponding to a demand response for maintaining a supply and demand balance of power; a small-scale vehicle group classification unit that classifies the vehicle groups into a plurality of small-scale vehicle groups; an expected value calculation unit that calculates a small-scale vehicle group expected value that is a maximum output sum of the small-scale vehicle groups; a request acceptance unit that accepts a request for the demand response; a request execution unit that causes the small-scale vehicle groups to execute the request for the demand response; and a priority order determination unit that determines priority order of the small-scale vehicle groups based on a time period and a type in which the request acceptance unit has accepted the request for the demand response.

### CROSS-REFFERENCE TO RELATED APPLICATIONS

This application is based on and claims the benefit of priority from Japanese Patent Application No. 2025-054026 filed in Japan on Mar. 27, 2025, the contents of which are hereby incorporated by reference in their entirety.

### BACKGROUND OF THE INVENTION

### Field of the Invention

The present invention relates to a power management apparatus and a power management method.

### Description of Related Art

In recent years, there is a vehicle-to-grid (V2G) technology for supplying electric power of a battery mounted on a vehicle to an electric power system. A demand response mechanism for balancing supply and demand of electric power by controlling charging and discharging of a battery mounted on a vehicle using this V2G technology is being studied. Hereinafter, the demand response may be referred to as "DR".

Japanese Unexamined Patent Application, First Publication No. 2022-115360 discloses a technique for the purpose of suppressing a consumer's disadvantage caused by not performing an appropriate supply and demand adjustment of electric power in response to a DR request. Japanese Unexamined Patent Application, First Publication

No. 2022-115360 discloses a power management apparatus that manages a demand response requesting a plurality of power adjustment resources electrically connectable to a power network for a supply and demand adjustment of electric power to the power network. Japanese Unexamined Patent Application, First Publication No. 2022-115360 is an exemplary example of a procedure of a process of updating priority order of the vehicle with respect to the DR request including a step of acquiring information on an SOC(S1) of a battery of the vehicle, a step of determining whether or not a start event and an end event of external charging have been received from the vehicle, a step of determining whether or not a traveling system of the vehicle has been activated, a step of acquiring information on an SOC(S2) of the battery from information transmitted from the vehicle in association with the activation of the traveling system, a step of calculating a difference ΔSOC(=S2-S1) between the SOC(S2) and the SOC(S1) and determining whether or not the ΔSOC is larger than a threshold value, and a step of updating the priority in order of lowering the priority of the vehicle with respect to the DR request (increasing DR) in a case where it is determined that the ΔSOC is larger than the threshold value.

### Citation List

### Patent Literature

PTL 1: Japanese Unexamined Patent Application, First Publication No. 2022-115360

### SUMMARY OF THE INVENTION

### Technical Problem

However, since a plurality of vehicles are processed one by one in Japanese Unexamined Patent Application, First Publication No. 2022-115360, in a case where the number of vehicles to be processed increases, there is a possibility that the communication processing cost or the arithmetic processing cost increases or the processing speed decreases. Therefore, it is desired to perform more efficient control.

In order to solve the above problem, an object of the present application is to provide a power management apparatus and a power management method capable of controlling a demand response more efficiently.

### Solution to Problem

As a means for solving the above problem, aspects of the present invention include following constitutions.

(1) A power management apparatus according to an aspect of the present invention (for example, the power management apparatus 1 according to an embodiment) includes: an acquisition unit (for example, an acquisition unit 11 in the embodiment) that acquires an assumed capacity and an assumed output of a plurality of vehicle groups corresponding to a demand response for maintaining a supply and demand balance of power; a small-scale vehicle group classification unit (for example, a small-scale vehicle group classification unit 23 according to the embodiment) that classifies the vehicle groups into a plurality of small-scale vehicle groups; an expected value calculation unit (for example, an expected value calculation unit 24 in the embodiment) that calculates a small-scale vehicle group expected value that is a maximum output sum of the small-scale vehicle groups; a request acceptance unit (for example, a request acceptance unit 20 in the embodiment) that accepts a request for the demand response; a request execution unit (for example, a request execution unit 21 in the embodiment) that causes the small-scale vehicle groups to execute the request for the demand response; and a priority order determination unit (for example, a priority order determination unit 22 in the embodiment) that determines priority order of the small-scale vehicle groups based on a time period and a type in which the request acceptance unit has accepted the request for the demand response.

According to this configuration, a control processing load can be distributed by classifying the plurality of vehicle groups corresponding to the demand response into the plurality of small-scale vehicle groups, and increasing control priority of a small-scale vehicle group having a high expected supply value per vehicle based on the time period and the type in which the request of the demand response is accepted. Therefore, the demand response can be controlled more efficiently.

(2) In the power management apparatus according to (1), the assumed capacity may include, as an average available supply amount, at least one of an average SOC and a battery capacity.

According to this configuration, the demand response can be more efficiently controlled in consideration of the average available supply amount (at least one of the average SOC and the battery capacity) of the plurality of vehicle groups corresponding to the demand response.

(3) In the power management apparatus according to (1) or (2), the expected value calculation unit may calculate the small-scale vehicle group expected value based on a charger output, a fitting ratio, an average SOC, a battery capacity, and a small-scale vehicle group vehicle number.

According to this configuration, an accuracy of the small-scale vehicle group expected value, which is the maximum output sum of the small-scale vehicle groups, can be further improved.

(4) In the power management apparatus according to any one of (1) to (3), the small-scale vehicle groups are classified into the following (1-1) to (1 -6).

(1-1) a first group in which a fitting time period is daytime, and an average available supply amount is lower than a predetermined range.

(1-2) a second group in which the fitting time period is daytime, and the average available supply amount is within the predetermined range.

(1-3) a third group in which the fitting time period is daytime, and the average available supply amount is higher than the predetermined range.

(1-4) a fourth group in which the fitting time period is night-time, and the average available supply amount is lower than the predetermined range.

(1-5) a fifth group in which the fitting time period is night-time, and the average available supply amount is within the predetermined range.

(1-6) a sixth group in which the fitting time period is night-time, and the average available supply amount is higher than the predetermined range.

The request for the demand response includes the following (2-1) to (2-4).

(2-1) a first request for increasing power demand in a daytime time period.

(2-2) a second request for reducing power demand in the daytime time period.

(2-3) a third request for increasing power demand in a night-time time period.

(2-4) a fourth request for reducing power demand in the night-time time period.

The priority order determination unit determines priority order of the first group, the second group, the third group, the fourth group, the fifth group, and the sixth group according to the first request, the second request, the third request, and the fourth request.

According to this configuration, it is possible to more efficiently control the demand response by determining the priority order of the groups of six patterns according to the request of four patterns.

(5) In the power management apparatus according to (4), in a case where the request of the demand response is the first request, the priority order determination unit may regard the first group as a large-output large-capacity pseudo battery, and the sixth group as a small-output small-capacity pseudo battery, and determine priority order from the first group, the second group, the third group, the fourth group, the fifth group, to the sixth group, the priority order being an order by which the groups are regarded as the large-output large-capacity pseudo battery.

In a case where the request of the demand response is the daytime time period, the priority order of the fitting time period being daytime is higher than that of the fitting time period being night-time. In addition, in a case where the request of the demand response is a request for increasing the power demand, the average available supply amount being lower than the predetermined range has higher priority order than the average available supply amount being within the predetermined range or being higher than the predetermined range. That is, in a case where the request of the demand response is the first request for increasing the power demand in the daytime time period, the priority order becomes higher if the fitting time period is the daytime and the average available supply amount is lower. According to this configuration, since the priority order is determined in consideration of the above, the demand response can be controlled more efficiently.

(6) In the power management apparatus according to (4), in a case where the request of the demand response is the second request, the priority order determination unit may regard the third group as a large-output large-capacity pseudo battery, and the fourth group as a small-output small-capacity pseudo battery, and determine priority order from the third group, the second group, the first group, the sixth group, the fifth group, to the fourth group, the priority order being an order by which the groups are regarded as the large-output large-capacity pseudo battery.

In a case where the request of the demand response is the second request for reducing the power demand in the daytime time period, the priority order becomes higher if the fitting time period is the daytime and the average available supply amount is higher. According to this configuration, since the priority order is determined in consideration of the above, the demand response can be controlled more efficiently.

(7) In the power management apparatus according to (4), in a case where the request of the demand response is the third request, the priority order determination unit may regard the first group as a small-output small-capacity pseudo battery, and the fourth group as a large-output large-capacity pseudo battery, and determine priority order from the fourth group, the fifth group, the sixth group, the first group, the second group, to the third group, the priority order being an order by which the groups are regarded as the large-output large-capacity pseudo battery.

In a case where the request of the demand response is the night-time time period, the priority order of the fitting time period being night-time is higher than that of the fitting time period being daytime. In addition, in a case where the request of the demand response is a request for increasing the power demand, the average available

supply amount being lower than the predetermined range has higher priority order than the average available supply amount being within the predetermined range or being higher than the predetermined range. That is, in a case where the request of the demand response is the third request for increasing the power demand in the night-time time period, the priority order becomes higher if the fitting time period is the night-time and the average available supply amount is lower. According to this configuration, since the priority order is determined in consideration of the above, the demand response can be controlled more efficiently.

(8) In the power management apparatus according to (4), in a case where the request of the demand response is the fourth request, the priority order determination unit may regard the first group as a small-output small-capacity pseudo battery, and the sixth group as a large-output large-capacity pseudo battery, and determine priority order from the sixth group, the fifth group, the fourth group, the third group, the second group, to the first group, the priority order being an order by which the groups are regarded as the large-output large-capacity pseudo battery.

In a case where the request of the demand response is the fourth request for reducing the power demand in the night-time time period, the priority order becomes higher if the fitting time period is the night-time and the average available supply amount is higher. According to this configuration, since the priority order is determined in consideration of the above, the demand response can be controlled more efficiently.

(9) A power management method according to an aspect of the present invention causes a computer (for example, the controller 10 in the embodiment) of a power management apparatus (for example, the power management apparatus 1 according to the embodiment) to perform the steps including: acquiring an assumed capacity and an assumed output of a plurality of vehicle groups corresponding to a demand response for maintaining a supply and demand balance of power; classifying the vehicle groups into a plurality of small-scale vehicle groups; calculating a small-scale vehicle group expected value that is a maximum output sum of the small-scale vehicle groups; accepting a request for the demand response; causing the small-scale vehicle groups to execute the request for the demand response; and determining priority order of the small-scale vehicle groups based on a time period and a type in which the request for the demand response has been accepted.

According to this method, a control processing load can be distributed by classifying the plurality of vehicle groups corresponding to the demand response into the plurality of small-scale vehicle groups, and increasing control priority of a small-scale vehicle group having a high expected supply value per vehicle based on the time period and the type in which the request of the demand response is accepted. Therefore, the demand response can be controlled more efficiently.

### Advantageous Effects of Invention

According to the aspect of the present invention, a demand response can be controlled more efficiently.

### BRIEF DESCRIPTION OF THE DRAWINGS

FIG. 1 is a diagram illustrating an example of a power management system including a power management apparatus according to an embodiment;

FIG. 2 is a diagram illustrating an example of a relationship between a list pattern and a small-scale vehicle group according to the embodiment;

FIG. 3 is a functional block diagram illustrating an example of a terminal device according to the embodiment;

FIG. 4 is a flowchart illustrating an example of a flow of a setting process of the power management apparatus according to the embodiment;

FIG. 5 is a diagram illustrating an example of an acceptable standard value setting screen displayed on the terminal device according to the embodiment;

FIG. 6 is a flowchart illustrating an example of a flow of DR control of the power management apparatus according to the embodiment;

FIG. 7 is a flowchart illustrating an example of a flow of stepwise group control corresponding to DR according to the embodiment;

FIG. 8 is a diagram illustrating an example of determination of priority order in a case where a DR request according to the embodiment is a daytime/increasing DR; and

FIG. 9 is a diagram illustrating an example of determination of priority order in a case where a DR request according to the embodiment is a night-time/reducing DR.

### DETAILED DESCRIPTION OF THE INVENTION

Hereinafter, a power management apparatus and a power management method according to an embodiment of the present invention will be described with reference to the drawings.

### Overall configuration

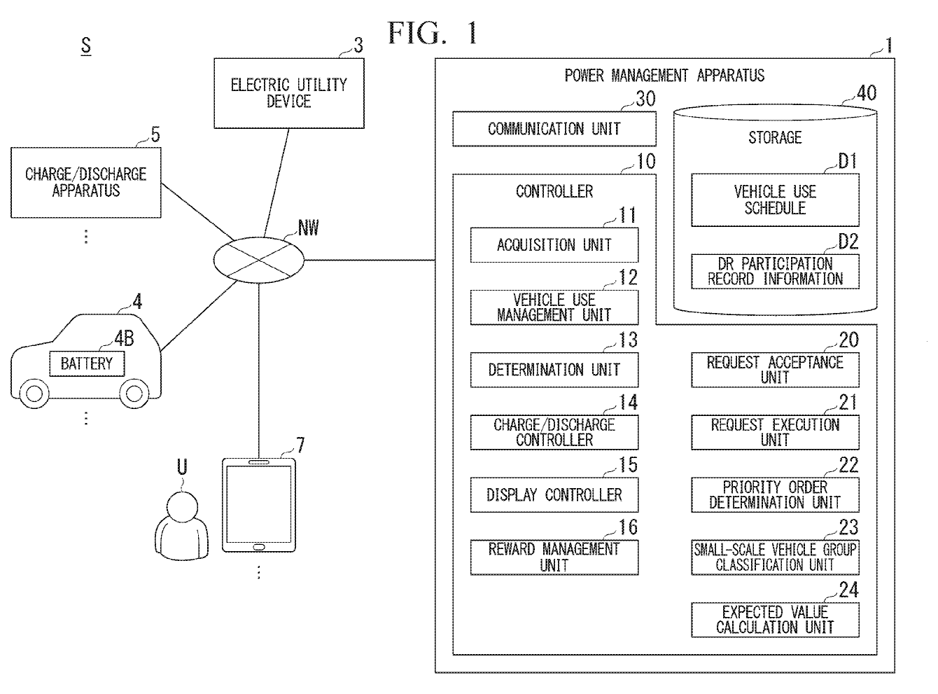

FIG. 1 is a diagram illustrating an example of a power management system S including a power management apparatus 1 according to the present embodiment.

The power management system S uses a technology of V2G that supplies electric power of a battery mounted on a vehicle to an electric power system. The power management system controls the demand response by controlling charging and discharging of the battery using the V2G technology. Hereinafter, the control of the demand response may be referred to as "DR control".

As illustrated in FIG. 1, the power management system S includes the power management apparatus 1, an electric utility device 3, a charge/discharge apparatus 5, a terminal device 7, and a vehicle 4. The power management apparatus 1, the electric utility device 3, the charge/discharge apparatus 5, the terminal device 7, the vehicle 4, and the like are communicably connected to each other via a communication network NW. Examples of the communication network include the Internet, a mobile communication network, a wide area network (WAN), a local area network (LAN), a cellular network, and the like.

The power management apparatus 1 performs overall control of the power management system S. The power management apparatus 1 controls charging and discharging of a battery 4B mounted on the vehicle 4 connected to the charge/discharge apparatus 5 according to a demand response plan received from the electric utility device 3, for example. Hereinafter, the demand response plan may be referred to as a "DR plan".

The vehicle 4 is, for example, a vehicle such as a four-wheel, a two-wheel, and a three-wheel vehicle. The drive source of the vehicle may be, for example, an electric motor. Alternatively, the driving source of the vehicle may be a combination of an internal combustion engine such as a diesel engine or a gasoline engine and an electric motor. The electric motor operates by using discharge power of the battery 4B which is a secondary battery or a fuel cell, or power generated by a generator connected to the internal combustion engine. Examples of the vehicle 4 include an electric vehicle, a hybrid vehicle, a fuel cell vehicle, an electric motorcycle, and the like. In the present embodiment, the vehicle is an electric vehicle (EV). Hereinafter, a battery mounted on an EV (vehicle) may be referred to as an "EV battery".

The electric utility device 3 is used by a company that supplies electricity, such as a power transmission and distribution company or a retail electricity company. The electric utility device 3 makes a DR plan according to the state of power storage, and notifies a consumer of electric power such as a company and a home. In the power management system S, the electric utility device 3 transmits the DR plan to the power management apparatus 1 via the communication network NW.

The charge/discharge apparatus 5 charges and discharges the EV battery. The charge/discharge apparatus 5 is installed, for example, in a residence of a user U of the vehicle 4 or a public charging station. The charge/discharge apparatus 5 charges the EV battery using system energy or renewable energy. The system energy is, for example, energy supplied from a general distribution line network (system, commercial power supply). The renewable energy is, for example, energy generated by a power generation apparatus provided in a house or the like.

In addition, the charge/discharge apparatus 5 discharges the EV battery by returning the electric power accumulated in the EV battery to the system.

The vehicle 4 is used by the user U, for example. The user U is, for example, a driver. Upon returning to his/her house, the user U connects (fits) a charging plug of the charge/discharge apparatus 5 provided in the house to a charging port of the vehicle 4, and thus charging and discharging of the vehicle 4 is enabled. Alternatively, the user U goes to a charging station and connects (fits) a charging plug of the charge/discharge apparatus 5 provided in the charging station and the charging port of the vehicle 4, and thus charging and discharging of the vehicle 4 is enabled.

The terminal device 7 is used by the user U, for example. The terminal device 7 is, for example, a smartphone, a tablet terminal, a general-purpose personal computer, or the like. The terminal device 7 may be connected to the vehicle 4 to function as an in-vehicle device. The terminal device 7 transmits information input by the user U to the power management apparatus 1 and the like. In addition, the terminal device 7 outputs information transmitted from the power management apparatus 1 to notify the user U of the information. The terminal device 7 implements various functions for participating in the DR control by executing a demand response application installed in advance. Hereinafter, the demand response application may be referred to as "DR application". Note that the various functions described above may be implemented using a general-purpose application program such as a web browser operating on the terminal device 7.

### Power management apparatus

The power management apparatus 1 includes a controller 10, a communication unit 30, and a storage 40.

The controller 10 controls an entire operation of the power management apparatus 1. The controller 10 includes an acquisition unit 11, a vehicle use management unit 12, a determination unit 13, a charge/discharge controller 14, a display controller 15, a reward management unit 16, a request acceptance unit 20, a request execution unit 21, a priority order determination unit 22, a small-scale vehicle group classification unit 23, and an expected value calculation unit 24.

These functional units of the controller 10 are implemented by, for example, a hardware processor (computer) such as a central processing unit (CPU) executing a program (software).

Some or all of these constituent elements may be implemented by a hardware such as a large-scale integration (LSI), an application specific integrated circuit (ASIC), a field-programmable gate array (FPGA), a graphics processing unit (GPU), or system on chip (SOC) or may be implemented by software and hardware in cooperation. In addition, the power management apparatus 1 is not limited to a single apparatus, and a plurality of apparatuses may cooperate to implement the respective functional units of the controller 10.

The acquisition unit 11 acquires various types of information from an external device via the communication network NW. In addition, the acquisition unit 11 acquires various types of information stored in the storage 40. For example, the acquisition unit 11 acquires input information of a vehicle use schedule by the user U of the vehicle 4, an acceptable standard value set by the user U, and the remaining capacity of the EV battery.

The acquisition unit 11 acquires an assumed capacity (average available supply amount) and an assumed output (attribute of a fitting time period) of a plurality of vehicle groups corresponding to a demand response for maintaining a supply and demand balance of power. The assumed capacity includes at least one of an average SOC and a battery capacity as an average available supply amount. The average SOC means an average value of remaining capacity (SOC: state of charge) of batteries mounted on a plurality of vehicles constituting a vehicle group. In the present embodiment, the average SOC is used as the average available supply amount.

The fitting time period corresponds to a time period in which the charging plug of the charge/discharge apparatus 5 and the charging port of the vehicle 4 are connected (fitted). The attribute of the fitting time period includes daytime (day), night-time, and the like. The daytime (day) time period corresponds to a period from around 9:00 to around 18:00. The night-time time period corresponds to a period from around 18:00 to around 24:00. Note that the attribute of the fitting time period includes morning (from around 6:00 to around 9:00), evening (from around 15:00 to around 18:00), morning (from 0:00 to 12:00), and afternoon (from 12:00 to 24:00).

The vehicle use management unit 12 manages a vehicle use schedule of the vehicle 4. For example, the vehicle use management unit 12 registers a vehicle use schedule input by the user U via the terminal device 7 in the vehicle use schedule D1 stored in the storage 40 in association with the user U or the vehicle 4.

The determination unit 13 determines whether or not the vehicle use schedule of the user U to be determined is input based on the vehicle use schedule D1.

The charge/discharge controller 14 may control the charge/discharge of the EV battery based on the determination result of the presence or absence of the input of the vehicle use schedule, the acceptable standard value, and the remaining capacity of the EV battery. In a case where the acceptable standard value is not set by the user U, the charge/discharge controller 14 may perform adjustment using a predetermined reference value (for example, DR usable SOC: 50% or the like) as the acceptable standard value.

The display controller 15 performs display control of the display unit of the terminal device 7. The display controller 15 generates notification information (information indicating display contents) to the user based on processing results of various functions of the controller 10, and transmits the notification information to the terminal device 7. As a result, various types of information are displayed on the display unit of the terminal device 7.

The reward management unit 16 manages the reward to the user U according to the record of participation in the exchange of power between the EV battery and the external power source (for example, an electric power system or an electric power transaction market). The reward management unit 16 may also give a reward to the user U in a case where the vehicle 4 stands by for participation in a state where electric power can be exchanged, in addition to the case where the vehicle 4 participates in the exchange of electric power. The reward in the case where the vehicle 4 stands by for participation may be set to be lower than the reward in the case where the vehicle 4 participates.

The small-scale vehicle group classification unit 23 classifies the vehicle group into a plurality of small-scale vehicle groups based on the assumed capacities (average available supply amounts) and the assumed outputs (attributes of the fitting time period) of the plurality of vehicle groups corresponding to the DR.

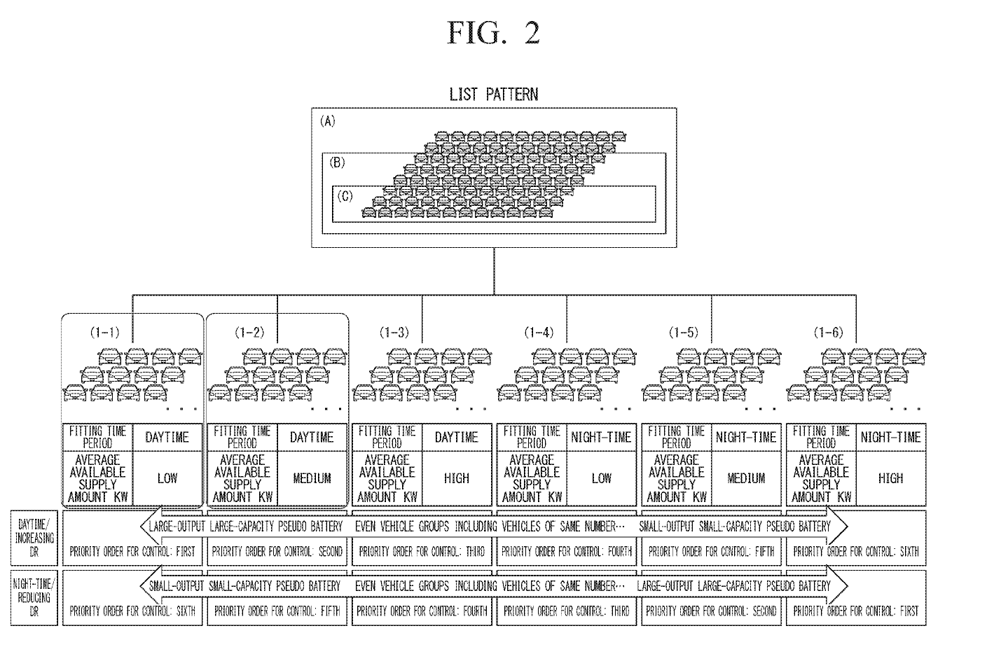

FIG. 2 is a diagram illustrating an example of a relationship between a list pattern and the small-scale vehicle groups according to the embodiment.

Referring also to FIGS. 1 and 2, in the present embodiment, DR-compatible vehicles are classified as small-scale vehicle groups for each average available supply amount (average SOC) and each attribute (day/night) of the fitting time period.

The DR-compatible vehicles are set in a list pattern, for example. For example, a vehicle group of 10000 vehicles may be set in the list pattern. The list pattern is classified into the following (A) to (C), for example.
(A) Vehicles that may participate in the DR depending on conditions.
(B) Vehicles to be converted into a pseudo-stationary battery.
(C) Vehicles actually responding to the DR.

The vehicles in (A) correspond to vehicles, charging to which affects the baseline. The scalability (number) in (A) corresponds to the number of all vehicles set in the list pattern.

The vehicles (B) correspond to vehicles capable of receiving a kW value reward. The scalability (number) in (B) corresponds to the number of vehicles planned for DR allocation.

The vehicles (C) correspond to vehicles capable of receiving the kWh value reward. The scalability (the number) in (C) corresponds to the number of vehicles (per unit time) for the DR allocation FB (feedback).

In the present embodiment, two-stage group control is executed as stepwise group control corresponding to the DR. In a first stage, a small-scale vehicle group that performs DR control is defined. In a second stage, a charge/discharge plan for the defined small-scale vehicle group is determined (maximum output in principle).

Since arithmetic processing, communication cost, and the like are required for the control, more efficient control is required. Specifically, it is preferable that a large output [kW] × duration [h] = actual supply amount [kWh] can be secured by control processing of one time. It is preferable to select and control a vehicle having a higher possibility of participating in the DR as the group control, since reducing the number of vehicles to be controlled in the charge/discharge plan leads to a reduction in server load.

The fitting time period is set to a time period in which the probability of fitting is relatively high due to the use pattern of the vehicle. In a case where the fitting time period is daytime, examples of the vehicle include a vehicle of a driving agency. In a case where the fitting time period is night, examples of the vehicle include a commuting vehicle of a company employee, a second car, and the like. The fitting time period affects the output. The average available supply amount affects the battery capacity.

The small-scale vehicle groups are classified into the following (1-1) to (1-6).

(1-1) a first group in which a fitting time period is daytime, and an average available supply amount is lower than a predetermined range.

(1-2) a second group in which the fitting time period is daytime, and the average available supply amount is within the predetermined range.

(1-3) a third group in which the fitting time period is daytime, and the average available supply amount is higher than the predetermined range.

(1-4) a fourth group in which the fitting time period is night-time, and the average available supply amount is lower than the predetermined range.

(1-5) a fifth group in which the fitting time period is night-time, and the average available supply amount is within the predetermined range.

(1-6) a sixth group in which the fitting time period is night-time, and the average available supply amount is higher than the predetermined range.

For the first to sixth groups classified into the above (1-1) to (1-6), it is assumed that the fitted charger output and battery specification (specification and the like) of the vehicle are constant. In a case where there is a difference in battery specification or the like between the groups, it is preferable to perform classification in consideration of the difference.

A request of the demand response includes the following (2-1) to (2-4).

(2-1) a first request for increasing power demand in a daytime time period.

(2-2) a second request for reducing power demand in the daytime time period.

(2-3) a third request for increasing power demand in a night-time time period.

(2-4) a fourth request for reducing power demand in the night-time time period.

Hereinafter, the request of the demand response may be referred to as "DR request". In addition, the request for increasing the power demand may be referred to as "increasing DR", the request for reducing the power demand may be referred to as "reducing DR", the request for increasing the power demand in the daytime time period may be referred to as "daytime/increasing DR", the request for reducing the power demand in the daytime time period may be referred to as "daytime/reducing DR", the request for increasing the power demand in the night-time time period may be referred to as "night-time/increasing DR", and the request for reducing the power demand in the night-time time period may be referred to as "night-time/reducing DR".

The expected value calculation unit 24 calculates a small-scale vehicle group expected value that is a maximum output sum of the small-scale vehicle group. The expected value calculation unit 24 calculates the small-scale vehicle group expected value based on the charger output, the fitting ratio, the average SOC, the battery capacity, and a small-scale vehicle group vehicle number.

The charger output corresponds to the output of the charge/discharge apparatus 5. The fitting ratio corresponds to a ratio of vehicles connected (fitted) to the charging plug of the charge/discharge apparatus 5 among the plurality of vehicles constituting the small-scale vehicle group. The average SOC corresponds to an average value of the SOCs of the plurality of vehicles constituting the small-scale vehicle group. The battery capacity corresponds to the battery capacity of each vehicle constituting the small-scale vehicle group. The small-scale vehicle group vehicle number corresponds to the number of vehicles (total number of vehicles) constituting the small-scale vehicle group.

The request acceptance unit 20 accepts the DR request.

The request execution unit 21 causes the small-scale vehicle group to execute the DR request. The request execution unit 21 may cause the power adjustment resources including the EV batteries as the small-scale vehicle group to execute the DR request. The power adjustment resource may include batteries (resources) other than the EV battery.

The priority order determination unit 22 determines priority order of the small-scale vehicle groups based on the time period and the type in which request acceptance unit 20 accepts the DR request. The time period in which the DR request is received includes daytime and night-time. The types of the DR request include increasing DR and reducing DR. The priority order determination unit 22 determines the priority order of the first group, the second group, the third group, the fourth group, the fifth group, and the sixth group according to the first request, the second request, the third request, and the fourth request described above.

In the present embodiment, a maximum output sum (small-scale vehicle group expected value as virtual value) is calculated from the charger output (kW), the fitting ratio, the average SOC (%), the battery capacity (kWh), and the small-scale vehicle group vehicle number for each of the first group to the sixth group of the small-scale vehicle groups classified into the above (1-1) to (1-6). Next, the size of the pseudo battery is classified into a large output/large capacity and a small output/small capacity for each of the DR requests (2-1) to (2-4). Next, the priority order of the small-scale vehicle groups to be used is changed.

The communication unit 30 communicates with external devices such as the electric utility device 3, the charge/discharge apparatus 5, the terminal device 7, and the vehicle 4 via the communication network NW. The communication unit 30 is, for example, a network card for connecting to the communication network NW.

The storage 40 stores various types of information necessary for the DR control. The storage 40 is realized by, for example, an HDD, a flash memory, an electrically erasable programmable read only memory (EEPROM), a read only memory (ROM), a random access memory (RAM), or the like. The storage 40 stores, for example, the vehicle use schedule D1, DR participation record information D2, and the like. Note that the storage 40 may be realized by another storage device, such as an external storage server device, connected via the communication network NW.

### Terminal device

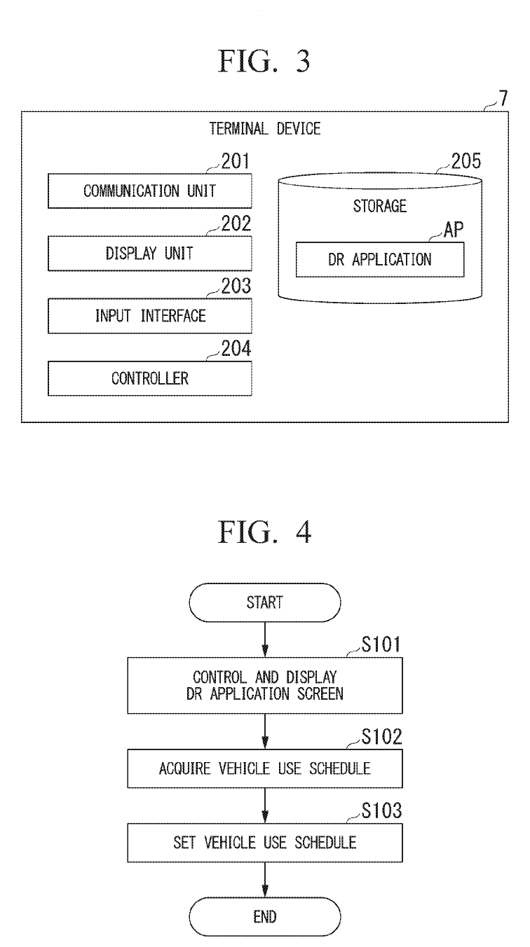

FIG. 3 is a functional block diagram illustrating an example of the terminal device 7 according to the embodiment.

As illustrated in FIG. 3, the terminal device 7 includes a communication unit 201, a display unit 202, an input interface 203, a controller 204, and a storage 205.

The communication unit 201 communicates with external devices such as the power management apparatus 1, the electric utility device 3, the charge/discharge apparatus 5, and the vehicle 4 via the communication network NW. The communication unit 201 is, for example, a network card for connecting to the communication network NW.

The display unit 202 displays various pieces of information on the DR control. The display unit 202 displays an image generated by the controller 204, a graphical user interface (GUI) for accepting various input operations from the user U, and the like. The display unit 202 is, for example, a liquid crystal display (LCD), an organic electro luminescence (EL) display, and the like.

The input interface 203 accepts various input operations from the user U, converts the accepted input operations into electrical signals, and outputs the electrical signals to the controller 204. For example, the input interface 203 includes a touch panel, a keyboard, a mouse, and the like.

The controller 204 controls an entire operation of the terminal device 7. For example, the controller 204 executes a DR application AP stored in the storage 205 to implement various functions for participating in the DR control. For example, the controller 204 realizes a vehicle use schedule input function, a setting function of an acceptable standard value, a reward management function, and the like.

The storage 205 stores various types of information related to the DR. The storage 205 is realized by, for example, an HDD, a flash memory, an EEPROM, a ROM, a RAM, or the like. The storage 205 stores, for example, the DR application AP, and the like.

### Setting process

FIG. 4 is a flowchart illustrating an example of a flow of a setting process of the power management apparatus 1 according to the embodiment. The process illustrated in FIG. 4 is started, for example, when the user U operates the terminal device 7 to activate the DR application AP.

As illustrated in FIG. 4, first, in response to the request transmitted from the terminal device 7, the display controller 15 transmits screen information for inputting various types of information related to the DR to the terminal device 7 (step S101).

In step S101, for example, the display controller 15 transmits screen information or the like for setting the vehicle use schedule to the terminal device 7. As a result, various screens (vehicle use schedule setting screen and the like) are displayed on the display unit 202 of the terminal device 7. The various screens include an acceptable standard value setting screen. After step S101, the process proceeds to step S102.

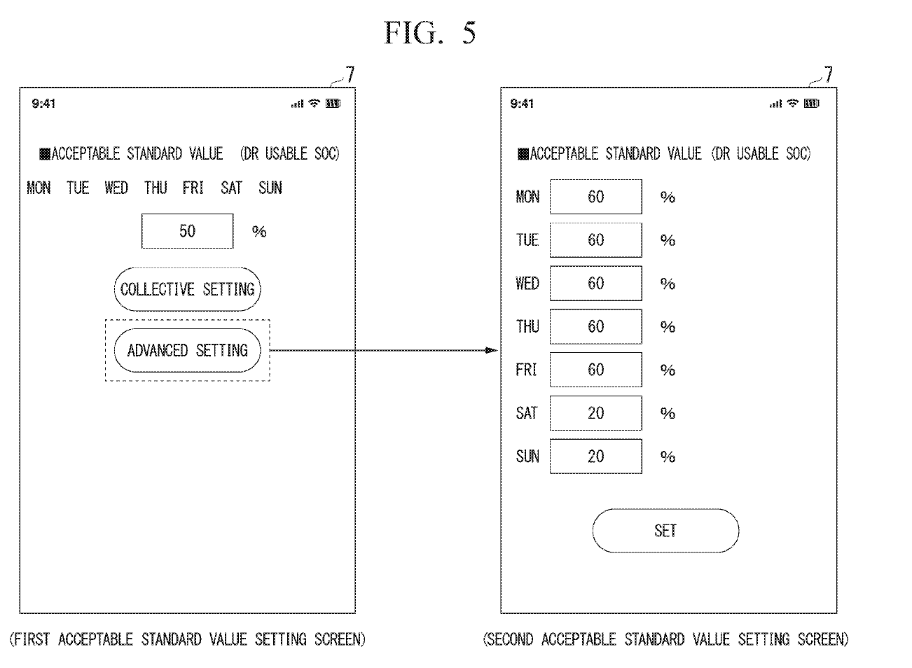

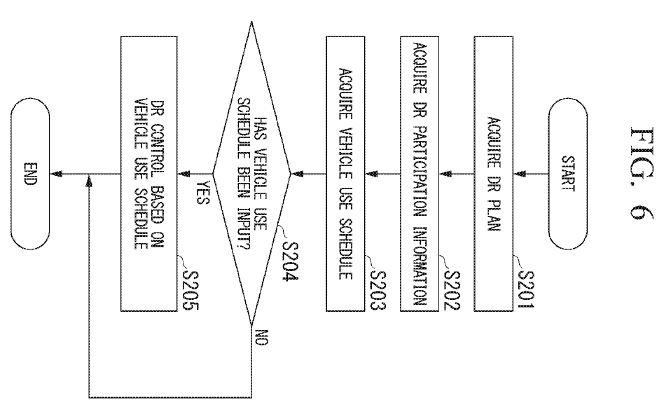

FIG. 5 is a diagram illustrating an example of an acceptable standard value setting screen displayed on the terminal device 7 according to the embodiment.

As illustrated in FIG. 5, on a first acceptable standard value setting screen, it may be possible to set an acceptable standard value (single value) common in the entire period (from Monday to Sunday). In addition, a second acceptable standard value setting screen may be displayed by pressing an "advanced setting" button provided on the first acceptable standard value setting screen. In the second acceptable standard value setting screen, the acceptable standard value (a plurality of values) may be set for each arbitrary period such as each day of the week. In addition, an acceptable standard value setting screen on which the acceptable standard value can be set for each time period may be used.

Returning to FIG. 4, in step S102, the acquisition unit 11 acquires the vehicle use schedule input by the user U via the terminal device 7 from the terminal device 7. In addition, the acquisition unit 11 may acquire the acceptable standard value input by the user U via the terminal device 7 from the terminal device 7. After step S102, the process proceeds to step S103.

In step S103, the vehicle use management unit 12 sets the acquired vehicle use schedule in the vehicle use schedule D1 stored in the storage 40 in association with the user U. Furthermore, in step S103, the acquired acceptable standard value may be set to the acceptable standard value stored in the storage 40 in association with the user U.

Thus, the process of this flowchart ends.

### DR control processing

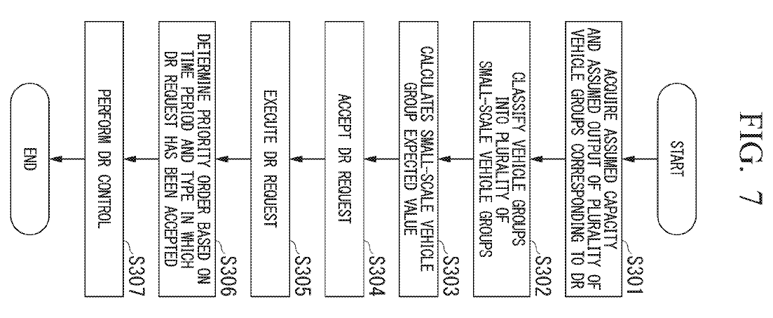

FIG. 6 is a flowchart illustrating an example of a flow of DR control of the power management apparatus 1 according to the embodiment. The process shown in FIG. 6 is started, for example, at a predetermined timing when the DR control is executed. Further, the description will be given assuming that the vehicle use schedule D1 set by each user U is already stored in the storage 40 of the power management apparatus 1. In addition, there are a plurality of vehicles 4 as targets of the DR control, and the power management apparatus 1 executes the following process on each of the plurality of vehicles 4.

As shown in FIG. 6, the acquisition unit 11 first acquires the DR plan transmitted from the electric utility device 3 (step S201). After step S201, the process proceeds to step S202.

In step S202, the acquisition unit 11 acquires, from the charge/discharge apparatus 5, information on the user of the vehicle who can participate in the DR control (the user of the vehicle whose charging port is fitted to the charging plug of charge/discharge apparatus 5). Hereinafter, the information on the user of the vehicle who can participate in the DR control may be referred to as "DR participation information". After step S202, the process proceeds to step S203.

In step S203, the acquisition unit 11 acquires each piece of information associated with the user included in the DR participation information from the vehicle use schedule D1 stored in the storage 40. After step S203, the process proceeds to step S204.

In step S204, the determination unit 13 determines whether or not the vehicle use schedule of the user U to be determined has been input based on the acquired vehicle use schedule. For example, the determination unit 13 determines whether or not the vehicle use schedule of the user U is input on the execution date of the DR control. In a case where it is determined that the vehicle use schedule is input (S204; YES), the process proceeds to step S205. On the other hand, in a case where it is determined that there is no input of the vehicle use schedule (S204; NO) and the process ends.

In step S205, the charge/discharge controller 14 performs the DR control based on the vehicle use schedule. For example, in a case where departure time "8:00" and home arrival time "17:00" are set as the vehicle use schedule, the charge/discharge controller 14 performs the DR control so as not to participate in the DR control during a period from 8:00 to 17:00. In addition, the charge/discharge controller 14 may control the charge/discharge of the battery 4B so that the remaining capacity of the battery 4B becomes a predetermined value or more at the timing of the departure time "8:00" (so as to secure the remaining capacity that does not affect the use of the vehicle).

In a case where it is determined that the vehicle use schedule is not input (S204; NO), the charge/discharge controller 14 may perform the DR control based on the acceptable standard value. For example, in a case where "SOC: 50%" is set as the acceptable standard value, the charge/discharge controller 14 may perform the DR control so as not to participate in the DR control when the acquired remaining capacity (SOC) of the EV battery is less than 50%.

FIG. 7 is a flowchart illustrating an example of a flow of the stepwise group control corresponding to the DR according to the embodiment. The process shown in FIG. 7 is started, for example, at a predetermined timing when the DR control is executed.

As illustrated in FIG. 7, first, the acquisition unit 11 acquires assumed capacities and assumed outputs of a plurality of vehicle groups corresponding to the DR (step S301). In step S301, the acquisition unit 11 acquires the average SOC as the assumed capacities (average available supply amount) of the plurality of vehicle groups. In step S301, the acquisition unit 11 acquires the attribute (day/night) of the fitting time period as the assumed output of the plurality of vehicle groups. After step S301, the process proceeds to step S302.

In step S302, the small-scale vehicle group classification unit 23 classifies the vehicle group into the plurality of small-scale vehicle groups. In step S302, the small-scale vehicle group classification unit 23 classifies the vehicle group into the above (1-1) to (1-6) as the small-scale vehicle groups. After step S302, the process proceeds to step S303.

In step S303, the expected value calculation unit 24 calculates a small-scale vehicle group expected value that is a maximum output sum of the small-scale vehicle groups. In step S303, the expected value calculation unit 24 calculates the small-scale vehicle group expected value based on the charger output, the fitting ratio, the average SOC, the battery capacity, and the small-scale vehicle group vehicle number. After step S303, the process proceeds to step S304.

In step S304, the request acceptance unit 20 accepts the DR request. After step S304, the process proceeds to step S305.

In step S305, the request execution unit 21 causes the small-scale vehicle groups to execute the DR request. After step S305, the process proceeds to step S306.

In step S306, the priority order determination unit 22 determines the priority order of the small-scale vehicle groups based on the time period and the type in which the request acceptance unit 20 accepts the DR request. In step S306, the priority order determination unit 22 determines the priority order of the first group, the second group, the third group, the fourth group, the fifth group, and the sixth group according to the first request, the second request, the third request, and the fourth request. After step S306, the process proceeds to step S307.

In step S307, the charge/discharge controller 14 performs the DR control on the small-scale vehicle group (EV battery) in an order of the determined priority order.

Thus, the process of this flowchart ends.

### Determination of priority order in a case where DR request is daytime/increasing DR

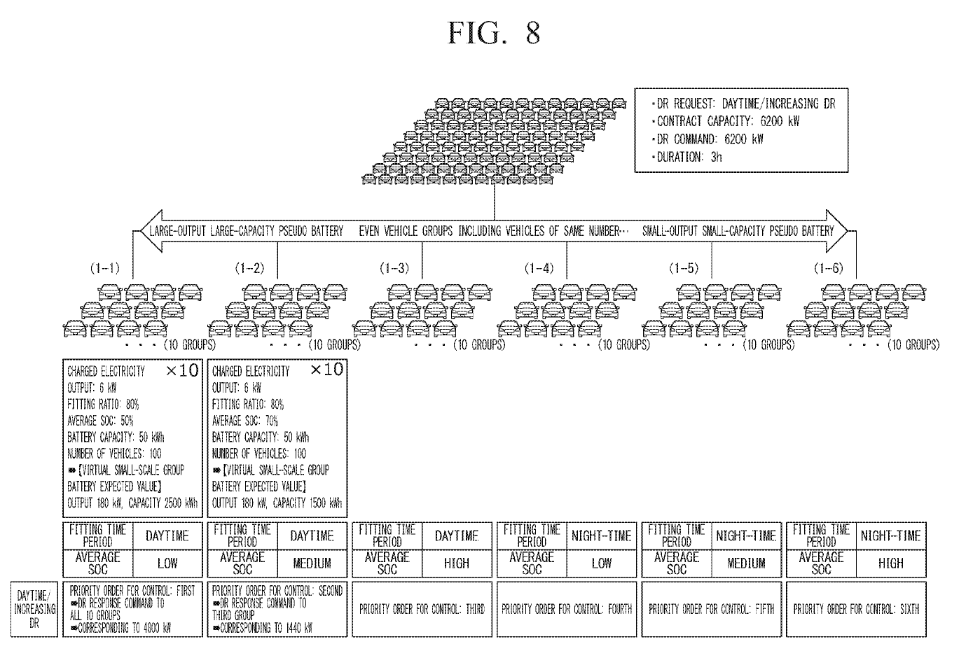

FIG. 8 is a diagram illustrating an example of determination of the priority order in a case where the DR request according to the embodiment is the daytime/increasing DR.

As illustrated in FIG. 8, in a case where the DR request is the daytime/increasing DR (first request), the priority order determination unit 22 regards the first group as a large-output large-capacity pseudo battery and regards the sixth group as a small-output small-capacity pseudo battery. In a case where the DR request is daytime/increasing DR (first request), the priority order determination unit 22 determines the priority order from the first group, the second group, the third group, the fourth group, the fifth group, to the sixth group, the priority order being an order by which the groups are regarded as the large-output large-capacity pseudo battery.

In the example of FIG. 8, as DR conditions, the DR request: daytime/increasing DR, the contract capacity: 6200 kW, the DR command: 6200 kW, and the duration: 3h are set. Each of the first to sixth groups classified into (1-1) to (1-6) illustrated in FIG. 8 is set as 10 small-scale vehicle groups.

The first group classified as (1-1) illustrated in FIG. 8 is set to the charger output: 6 kW, the fitting ratio: 80%, the average SOC: 50%, the battery capacity: 50 kWh, and the number of vehicles: 100. In the first group classified into (1-1) illustrated in FIG. 8, the virtual small-scale group battery expected value (small-scale vehicle group expected value as a virtual value) is the output: 480 kW (= charger output: 6 kW × fitting ratio: 80% × number of vehicles: 100), and the capacity (chargeable capacity): 2500 kWh (= (SOC: 100% - average SOC: 50%) × battery capacity: 50 kWh × number of vehicles: 100).

The second group classified as (1-2) illustrated in FIG. 8 is set to the charger output: 6 kW, the fitting ratio: 80%, the average SOC: 70%, the battery capacity: 50 kWh, and the number of vehicles: 100. In the second group classified as (1-2) illustrated in FIG. 8, the virtual small-scale group battery expected value (small-scale vehicle group expected value as a virtual value) is the output: 480 kW (= charger output: 6 kW × fitting ratio: 80% × number of vehicles: 100), and the capacity (chargeable capacity): 1500 kWh (= (SOC: 100% - average SOC: 70%) × battery capacity: 50 kWh × number of vehicles: 100).

In the example of FIG. 8, the priority order determination unit 22 determines the priority order in the order of the first group classified as (1-1) and the second group classified as (1-2). In this case, the charge/discharge controller 14 controls the increasing DR in the order of the first group classified as (1-1) and the second group classified as (1-2). The control of the increasing DR is control for increasing power demand in response to a request from an electricity provider or the like. Upon starting of the control of the increasing DR, the battery is charged and the SOC increases.

The charge/discharge controller 14 issues the DR response command to the first group classified as (1-1) to cause all 10 groups to charge the batteries (4800 kW = output: 480 kW × small-scale vehicle group: 10 groups). Next, the charge/discharge controller 14 issues the DR response command to the second group classified as (1-2) to cause three of the 10 groups to charge the batteries (1440 kW = output: 480 kW × small-scale vehicle group: three groups). As a result, an output corresponding to 6240 kW (4800 kW + 1440 kW) is expected. Therefore, it is preferable that the control is started, and the subsequent control is performed in units of small groups by F/B control (feedback control).

### Determination of priority order in a case where DR request is night-time/reducing DR

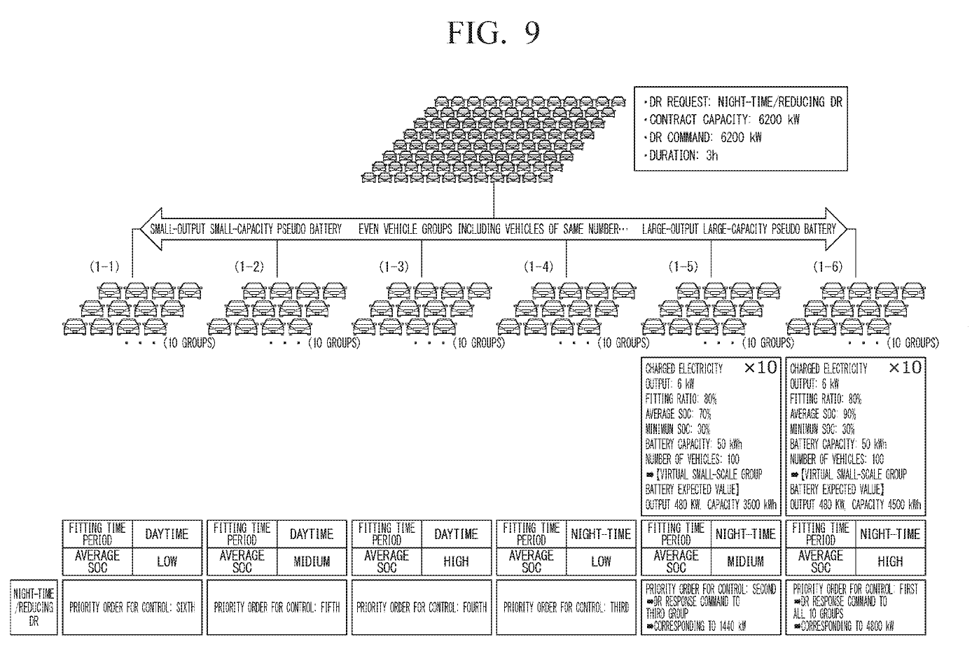

FIG. 9 is a diagram illustrating an example of determination of priority order in a case where the DR request according to the embodiment is the night-time/reducing DR.

As illustrated in FIG. 9, in a case where the DR request is the night-time/reducing DR (fourth request), the priority order determination unit 22 regards the first group as a small-output small-capacity pseudo battery and regards the sixth group as a large-output large-capacity pseudo battery. In a case where the DR request is night-time/reducing DR (fourth request), the priority order determination unit 22 determines the priority order from the sixth group, the fifth group, the fourth group, the third group, the second group, to the first group, the priority order being an order by which the groups are regarded as the large-output large-capacity pseudo battery.

In the example of FIG. 9, as DR conditions, the DR request: night-time/reducing DR, the contract capacity: 6200 kW, the DR command: 6200 kW, and the duration: 3h are set. Each of the first to sixth groups classified into (1-1) to (1-6) illustrated in FIG. 9 is set as 10 small-scale vehicle groups.

The fifth group classified as (1-5) illustrated in FIG. 9 is set to the charger output: 6 kW, the fitting ratio: 80%, the average SOC: 70%, minimum SOC: 30%, the battery capacity: 50 kWh, and the number of vehicles: 100. In the fifth group classified as (1-5) illustrated in FIG. 9, the virtual small-scale group battery expected value (small-scale vehicle group expected value as a virtual value) is the output: 480 kW (= charger output: 6 kW × fitting ratio: 80% × number of vehicles: 100), and the capacity (dischargeable capacity): 3500 kWh (= average SOC: 70% × battery capacity: 50 kWh × number of vehicles: 100).

The sixth group classified as (1-6) illustrated in FIG. 9 is set to the charger output: 6 kW, the fitting ratio: 80%, the average SOC: 90%, the minimum SOC: 30%, the battery capacity: 50 kWh, and the number of vehicles: 100. In the sixth group classified into (1-6) illustrated in FIG. 9, the virtual small-scale group battery expected value (small-scale vehicle group expected value as the virtual value) is the output: 480 kW (= charger output: 6 kW × fitting ratio: 80% × the number of vehicles: 100), and the capacity (dischargeable capacity): 4500 kWh (= average SOC: 90% × battery capacity: 50 kWh × the number of vehicles: 100).

In the example of FIG. 9, the priority order determination unit 22 determines the priority order in the order of the sixth group classified as (1-6) and the fifth group classified as (1-5). In this case, the charge/discharge controller 14 controls the reducing DR in the order of the sixth group classified as (1-6) and the fifth group classified as (1-5). The control of the reducing DR is control for reducing power demand in response to a request from an electricity provider or the like. Upon starting of the control of the reducing DR, the battery is discharged and the SOC decreases.

The charge/discharge controller 14 issues the DR response command to the sixth group classified as (1-6) to cause all 10 groups to discharge the batteries (4800 kW = output: 480 kW × small-scale vehicle group: 10 groups). Next, the charge/discharge controller 14 issues the DR response command to the fifth group classified as (1-5) to cause three of the 10 groups to discharge the batteries (1440 kW = output: 480 kW × small-scale vehicle group: three groups). As a result, an output corresponding to 6240 kW (4800 kW + 1440 kW) is expected. Therefore, it is preferable that the control is started, and the subsequent control is performed in units of small groups by F/B control (feedback control).

Although not illustrated, in a case where the DR request is the daytime/reducing DR (second request), the priority order determination unit 22 regards the third group as a large-output large-capacity pseudo battery and regards the fourth group as a small-output small-capacity pseudo battery. In a case where the DR request is daytime/reducing DR (second request), the priority order determination unit 22 determines the priority order from the third group, the second group, the first group, the sixth group, the fifth group, to the fourth group, the priority order being an order by which the groups are regarded as the large-output large-capacity pseudo battery.

In the case that the DR request is the night-time/increasing DR (third request), the priority order determination unit 22 regards the first group as a small-output small-capacity pseudo battery, and regards the fourth group as a large-output large-capacity pseudo battery. In a case where the DR request is night-time/increasing DR (third request), the priority order determination unit 22 determines the priority order from the fourth group, the fifth group, the sixth group, the first group, the second group, to the third group, the priority order being an order by which the groups are regarded as the large-output large-capacity pseudo battery.

### Operation and effects

As described above, the power management apparatus 1 according to the above embodiment includes: the acquisition unit 11 that acquires an assumed capacity and an assumed output of a plurality of vehicle groups corresponding to a demand response for maintaining a supply and demand balance of power; the small-scale vehicle group classification unit 23 that classifies the vehicle groups into a plurality of small-scale vehicle groups; the expected value calculation unit 24 that calculates a small-scale vehicle group expected value that is a maximum output sum of the small-scale vehicle groups; the request acceptance unit 20 that accepts a request for the demand response; the request execution unit 21 that causes the small-scale vehicle groups to execute the request for the demand response; and the priority order determination unit 22 that determines priority order of the small-scale vehicle groups based on a time period and a type in which the request acceptance unit 20 has accepted the request for the demand response.

According to this configuration, a control processing load can be distributed by classifying the plurality of vehicle groups corresponding to the demand response into the plurality of small-scale vehicle groups, and increasing control priority of a small-scale vehicle group having a high expected supply value per vehicle based on the time period and the type in which the request of the demand response is accepted. Therefore, the demand response can be controlled more efficiently.

In the above embodiment, the assumed capacity includes, as an average available supply amount, at least one of an average SOC and a battery capacity.

According to this configuration, the demand response can be more efficiently controlled in consideration of the average available supply amount (at least one of the average SOC and the battery capacity) of the plurality of vehicle groups corresponding to the demand response.

In the above embodiment, the expected value calculation unit 24 calculates the small-scale vehicle group expected value based on the charger output, the fitting ratio, the average SOC, the battery capacity, and the small-scale vehicle group vehicle number.

According to this configuration, an accuracy of the small-scale vehicle group expected value, which is the maximum output sum of the small-scale vehicle groups, can be further improved.

In the above embodiment, the small-scale vehicle groups are classified into the following (1-1) to (1-6).

(1-1) a first group in which a fitting time period is daytime, and an average available supply amount is lower than a predetermined range.

(1-2) a second group in which the fitting time period is daytime, and the average available supply amount is within the predetermined range.

(1-3) a third group in which the fitting time period is daytime, and the average available supply amount is higher than the predetermined range.

(1-4) a fourth group in which the fitting time period is night-time, and the average available supply amount is lower than the predetermined range.

(1-5) a fifth group in which the fitting time period is night-time, and the average available supply amount is within the predetermined range.

(1-6) a sixth group in which the fitting time period is night-time, and the average available supply amount is higher than the predetermined range.

The request of the demand response includes the following (2-1) to (2-4).

(2-1) a first request for increasing power demand in a daytime time period.

(2-2) a second request for reducing power demand in the daytime time period.

(2-3) a third request for increasing power demand in a night-time time period.

(2-4) a fourth request for reducing power demand in the night-time time period.

The priority order determination unit 22 determines the priority order of the first group, the second group, the third group, the fourth group, the fifth group, and the sixth group according to the first request, the second request, the third request, and the fourth request.

According to this configuration, it is possible to more efficiently control the demand response by determining the priority order of the groups of six patterns according to the request of four patterns.

In the above embodiment, in a case where the request of the demand response is the first request, the priority order determination unit 22 regards the first group as a large-output large-capacity pseudo battery, and the sixth group as a small-output small-capacity pseudo battery; and determines priority order from the first group, the second group, the third group, the fourth group, the fifth group, to the sixth group, the priority order being an order by which the groups are regarded as the large-output large-capacity pseudo battery.

In a case where the request of the demand response is the daytime time period, the priority order of the fitting time period being daytime is higher than that of the fitting time period being night-time. In addition, in a case where the request of the demand response is a request for increasing the power demand, the average available supply amount being lower than the predetermined range has higher priority order than the average available supply amount being within the predetermined range or being higher than the predetermined range. That is, in a case where the request of the demand response is the first request for increasing the power demand in the daytime time period, the priority order becomes higher if the fitting time period is the daytime and the average available supply amount is lower. According to this configuration, since the priority order is determined in consideration of the above, the demand response can be controlled more efficiently.

In the above embodiment, in a case where the request of the demand response is the second request, the priority order determination unit 22 regards the third group as a large-output large-capacity pseudo battery, and the fourth group as a small-output small-capacity pseudo battery; and determines priority order from the third group, the second group, the first group, the sixth group, the fifth group, to the fourth group, the priority order being an order by which the groups are regarded as the large-output large-capacity pseudo battery.

In a case where the request of the demand response is the second request for reducing the power demand in the daytime time period, the priority order becomes higher if the fitting time period is the daytime and the average available supply amount is higher. According to this configuration, since the priority order is determined in consideration of the above, the demand response can be controlled more efficiently.

In the above embodiment, in a case where the request of the demand response is the third request, the priority order determination unit 22 regards the first group as a small-output small-capacity pseudo battery, and the fourth group as a large-output large- capacity pseudo battery; and determines priority order from the fourth group, the fifth group, the sixth group, the first group, the second group, to the third group, the priority order being an order by which the groups are regarded as the large-output large-capacity pseudo battery.

In a case where the request of the demand response is the night-time time period, the priority order of the fitting time period being night-time is higher than that of the fitting time period being daytime. In addition, in a case where the request of the demand response is a request for increasing the power demand, the average available supply amount being lower than the predetermined range has higher priority order than the average available supply amount being within the predetermined range or being higher than the predetermined range. That is, in a case where the request of the demand response is the third request for increasing the power demand in the night-time time period, the priority order becomes higher if the fitting time period is the night-time and the average available supply amount is lower. According to this configuration, since the priority order is determined in consideration of the above, the demand response can be controlled more efficiently.

In the above embodiment, in a case where the request of the demand response is the fourth request, the priority order determination unit 22 regards the first group as a small-output small-capacity pseudo battery, and the sixth group as a large-output large-capacity pseudo battery; and determines priority order from the sixth group, the fifth group, the fourth group, the third group, the second group, to the first group, the priority order being an order by which the groups are regarded as the large-output large-capacity pseudo battery.

In a case where the request of the demand response is the fourth request for reducing the power demand in the night-time time period, the priority order becomes higher if the fitting time period is the night-time and the average available supply amount is higher. According to this configuration, since the priority order is determined in consideration of the above, the demand response can be controlled more efficiently.

The power management method of the above embodiment causes the computer (controller 10) of the power management apparatus 1 to perform the steps including: acquiring an assumed capacity and an assumed output of a plurality of vehicle groups corresponding to a demand response for maintaining a supply and demand balance of power; classifying the vehicle groups into a plurality of small-scale vehicle groups; calculating a small-scale vehicle group expected value that is a maximum output sum of the small-scale vehicle groups; accepting a request for the demand response; causing the small-scale vehicle groups to execute the request for the demand response; and determining priority order of the small-scale vehicle groups based on a time period and a type in which the request for the demand response has been accepted.

According to this method, a control processing load can be distributed by classifying the plurality of vehicle groups corresponding to the demand response into the plurality of small-scale vehicle groups, and increasing control priority of a small-scale vehicle group having a high expected supply value per vehicle based on the time period and the type in which the request of the demand response is accepted. Therefore, the demand response can be controlled more efficiently.

In the future, it is expected that the scale of the vehicle groups to be subjected to the DR control will be expanded, and restrictions on cloud design due to the expansion of the group scale will be increased. In this case, there is a concern that the technical difficulty increases, and that even if it is possible to technically respond, the server use cost (server operation cost) increases.

On the other hand, according to the present embodiment, by performing the above-described stepwise group control, the number of vehicles to be controlled in a charge/discharge plan can be reduced. This makes it possible to suppress an increase in the server use cost (server operation cost). Further, it is possible to distribute the control processing load by setting small-scale vehicle groups between individual vehicles and one group corresponding to the list pattern. As a result, the group scale of one list pattern can be expanded, and it is possible to perform group control of a larger number of vehicles. For example, it is possible to more efficiently perform the group control of more than 10000 vehicles.

Further, the EV battery has a gap (fitting gap) in a period while being connected (fitted) to the charging plug of the charge/discharge apparatus, and is a resource with high uncertainty compared to the system storage battery. According to the present embodiment, it is possible to reduce the uncertainty by classifying the group control for each characteristic as described above. For example, in a case of dividing into the six groups as described above, it is preferable to divide into the groups in long-term operation. Further, it is possible to continuously output a predetermined output (for example, equivalent to 4800 kW) for a predetermined period (for example, 3 hours) by confirming that the output can be made while satisfying the capacity constraint.

### Modifications

In the above embodiment, an example in which the assumed capacity includes, as the average available supply amount, at least one of the average SOC and the battery capacity has been described, but the present invention is not limited to this. For example, the assumed capacity may include an amount other than the average SOC and the battery capacity as the average available supply amount. The mode of the assumed capacity can be changed according to the design specification.

In the above embodiment, an example has been described in which the expected value calculation unit calculates the small-scale vehicle group expected value based on the charger output, the fitting ratio, the average SOC, the battery capacity, and the small-scale vehicle group vehicle number, but the present invention is not limited to this. For example, the expected value calculation unit may calculate the small-scale vehicle group expected value based on information other than the charger output, the fitting ratio, the average SOC, the battery capacity, and the small-scale vehicle group vehicle number. The mode of calculating the small-scale vehicle group expected value can be changed according to the design specification.

In the above embodiment, the small-scale vehicle groups are classified into the following (1-1) to (1 -6).

(1-1) a first group in which a fitting time period is daytime, and an average available supply amount is lower than a predetermined range.

(1-2) a second group in which the fitting time period is daytime, and the average available supply amount is within the predetermined range.

(1-3) a third group in which the fitting time period is daytime, and the average available supply amount is higher than the predetermined range.

(1-4) a fourth group in which the fitting time period is night-time, and the average available supply amount is lower than the predetermined range.

(1-5) a fifth group in which the fitting time period is night-time, and the average available supply amount is within the predetermined range.

(1-6) a sixth group in which the fitting time period is night-time, and the average available supply amount is higher than the predetermined range.

The request of the demand response includes the following (2-1) to (2-4).

(2-1) a first request for increasing power demand in a daytime time period.

(2-2) a second request for reducing power demand in the daytime time period.

(2-3) a third request for increasing power demand in a night-time time period.

(2-4) a fourth request for reducing power demand in the night-time time period.

The example in which the priority order determination unit determines the priority order of the first group, the second group, the third group, the fourth group, the fifth group, and the sixth group according to the first request, the second request, the third request, and the fourth request has been described, but the present invention is not limited to this. For example, the priority order determination unit may determine the priority order of the first group, the second group, the third group, the fourth group, the fifth group, and the sixth group according to a request different from the first request, the second request, the third request, and the fourth request. The mode of determining the priority order of the small-scale vehicle groups can be changed according to the design specification.

The above embodiment is described taking an example in which, in a case where the request of the demand response is the first request, the priority order determination unit regards the first group as a large-output large-capacity pseudo battery, and the sixth group as a small-output small-capacity pseudo battery; and determines priority order from the first group, the second group, the third group, the fourth group, the fifth group,

to the sixth group, the priority order being an order by which the groups are regarded as the large-output large-capacity pseudo battery, but the present invention is not limited to this. For example, in a case where the request of the demand response is the first request, the priority order determination unit may determine priority order different from the order from the first group, the second group, the third group, the fourth group, the fifth group, to the sixth group. The mode of determining the priority order of the small-scale vehicle groups in a case where the request of the demand response is the first request can be changed according to the design specification.

The above embodiment is described taking an example in which, in a case where the request of the demand response is the second request, the priority order determination unit regards the third group as a large-output large-capacity pseudo battery, and the fourth group as a small-output small-capacity pseudo battery; and determines priority order from the third group, the second group, the first group, the sixth group, the fifth group, to the fourth group, the priority order being an order by which the groups are regarded as the large-output large-capacity pseudo battery, but the present invention is not limited to this. For example, in a case where the request of the demand response is the second request, the priority order determination unit may determine priority order different from the order from the third group, the second group, the first group, the sixth group, the fifth group, to the fourth group. The mode of determining the priority order of the small-scale vehicle groups in a case where the request of the demand response is the second request can be changed according to the design specification.

The above embodiment is described taking an example in which, in a case where the request of the demand response is the third request, the priority order determination unit regards the first group as a small-output small-capacity pseudo battery, and the fourth group as a large-output large-capacity pseudo battery; and determines priority order from the fourth group, the fifth group, the sixth group, the first group, the second group, to the third group, the priority order being an order by which the groups are regarded as the large-output large-capacity pseudo battery, but the present invention is not limited to this. For example, in a case where the request of the demand response is the third request, the priority order determination unit may determine priority order different from the order from the fourth group, the fifth group, the sixth group, the first group, the second group, to the third group. The mode of determining the priority order of the small-scale vehicle groups in a case where the request of the demand response is the third request can be changed according to the design specification.

The above embodiment is described taking an example in which, in a case where the request of the demand response is the fourth request, the priority order determination unit regards the first group as a small-output small-capacity pseudo battery, and the sixth group as a large-output large-capacity pseudo battery; and determines priority order from the sixth group, the fifth group, the fourth group, the third group, the second group, to the first group, the priority order being an order by which the groups are regarded as the large-output large-capacity pseudo battery, but the present invention is not limited to this. For example, in a case where the request of the demand response is the fourth request, the priority order determination unit may determine priority order different from the order from the sixth group, the fifth group, the fourth group, the third group, the second group, and the first group. The mode of determining the priority order of the small-scale vehicle groups in a case where the request of the demand response is the fourth request can be changed according to the design specification.

Heretofore, the modes for carrying out the present invention have been described using the embodiments, but the present invention is not limited to the embodiments described above, and various modifications and substitutions can be made without departing from the gist of the present invention.

What is claimed is:

1. A power management apparatus comprising:
an acquisition unit that acquires an assumed capacity and an assumed output of a plurality of vehicle groups corresponding to a demand response for maintaining a supply and demand balance of power;
a small-scale vehicle group classification unit that classifies the vehicle groups into a plurality of small-scale vehicle groups;
an expected value calculation unit that calculates a small-scale vehicle group expected value that is a maximum output sum of the small-scale vehicle groups;
a request acceptance unit that accepts a request for the demand response;
a request execution unit that causes the small-scale vehicle groups to execute the request for the demand response; and
a priority order determination unit that determines priority order of the small-scale vehicle groups based on a time period and a type in which the request acceptance unit has accepted the request for the demand response.

2. The power management apparatus according to claim 1, wherein
the assumed capacity includes, as an average available supply amount, at least one of an average SOC and a battery capacity.

3. The power management apparatus according to claim 1, wherein
the expected value calculation unit calculates the small-scale vehicle group expected value based on a charger output, a fitting ratio, an average SOC, a battery capacity, and a small-scale vehicle group vehicle number.

4. The power management apparatus according to claim 1, wherein
the small-scale vehicle groups are classified into:
(1-1) a first group in which a fitting time period is daytime, and an average available supply amount is lower than a predetermined range;
(1-2) a second group in which the fitting time period is daytime, and the average available supply amount is within the predetermined range;
(1-3) a third group in which the fitting time period is daytime, and the average available supply amount is higher than the predetermined range;
(1-4) a fourth group in which the fitting time period is night-time, and the average available supply amount is lower than the predetermined range;
(1-5) a fifth group in which the fitting time period is night-time, and the average available supply amount is within the predetermined range; and
(1-6) a sixth group in which the fitting time period is night-time, and the average available supply amount is higher than the predetermined range,
the request for the demand response includes:
(2-1) a first request for increasing power demand in daytime time period;
(2-2) a second request for reducing power demand in daytime time period;
(2-3) a third request for increasing power demand in night-time time period; and
(2-4) a fourth request for reducing power demand in night-time time period, and
the priority order determination unit determines priority order of the first group, the second group, the third group, the fourth group, the fifth group, and the sixth group according to the first request, the second request, the third request, and the fourth request.

5. The power management apparatus according to claim 4, wherein
in a case where the request of the demand response is the first request,
the priority order determination unit:
regards the first group as a large-output large-capacity pseudo battery, and the sixth group as a small-output small-capacity pseudo battery; and
determines priority order from the first group, the second group, the third group, the fourth group, the fifth group, to the sixth group, the priority order being an order by which the groups are regarded as the large-output large-capacity pseudo battery.

6. The power management apparatus according to claim 4, wherein
in a case where the request of the demand response is the second request,
the priority order determination unit:
regards the third group as a large-output large-capacity pseudo battery, and the fourth group as a small-output small-capacity pseudo battery; and
determines priority order from the third group, the second group, the first group, the sixth group, the fifth group, to the fourth group, the priority order being an order by which the groups are regarded as the large-output large-capacity pseudo battery.

7. The power management apparatus according to claim 4, wherein
in a case where the request of the demand response is the third request,
the priority order determination unit:
regards the first group as a small-output small-capacity pseudo battery, and the fourth group as a large-output large-capacity pseudo battery; and
determines priority order from the fourth group, the fifth group, the sixth group, the first group, the second group, to the third group, the priority order being an order by which the groups are regarded as the large-output large-capacity pseudo battery.

8. The power management apparatus according to claim 4, wherein
in a case where the request of the demand response is the fourth request,
the priority order determination unit:
regards the first group as a small-output small-capacity pseudo battery, and the sixth group as a large-output large-capacity pseudo battery; and
determines priority order from the sixth group, the fifth group, the fourth group, the third group, the second group, to the first group, the priority order being an order by which the groups are regarded as the large-output large-capacity pseudo battery.

9. A power management method that causes a computer of the power management apparatus to perform the steps comprising:
acquiring an assumed capacity and an assumed output of a plurality of vehicle groups corresponding to a demand response for maintaining a supply and demand balance of power;
classifying the vehicle groups into a plurality of small-scale vehicle groups;
calculating a small-scale vehicle group expected value that is a maximum output sum of the small-scale vehicle groups;
accepting a request for the demand response;
causing the small-scale vehicle groups to execute the request for the demand response; and
determining priority order of the small-scale vehicle groups based on a time period and a type in which the request for the demand response has been accepted.
